(19) United States
(12) Patent Application Publication
(10) Pub. No.: US 2024/0411088 A1
(43) Pub. Date: Dec. 12, 2024

(54) FERRULE HOLDING STRUCTURE

(71) Applicant: Fujikura Ltd., Tokyo (JP)

(72) Inventor: Shuhei Kanno, Sakura-shi (JP)

(73) Assignee: Fujikura Ltd., Tokyo (JP)

(21) Appl. No.: 18/700,755

(22) PCT Filed: Apr. 18, 2022
(86) PCT No.: PCT/JP2022/018022

§ 371 Date: Apr. 12, 2024

(30) Foreign Application Priority Data
Oct. 20, 2021 (JP) 2021-171544

(51) Int. Cl. G02B 6/38

(52) U.S. Cl. CPC G02B 6/3869

(57) ABSTRACT

A ferrule holding structure includes a ferrule into which an optical fiber is inserted from a rear end of the ferrule to a connection surface at a front end of the ferrule and that holds the optical fiber, a biasing member that biases the ferrule in a forward direction from the rear end toward the connection surface, a housing that accommodates the biasing member and at least a part of the ferrule, and a support member that engages with the housing and that supports a rear end side of the biasing member. The support member includes a guide portion that guides the support member into the housing in an intersecting direction and a pressing face that presses the biasing member in the forward direction along with a movement of the support member in the intersecting direction to a position where the support member engages with the housing.

### CROSS-REFERENCE TO RELATED APPLICATIONS

The present application claims priority to Japanese Patent Application No. 2021-171544, filed Oct. 20, 2021. The contents of this application are incorporated herein by reference in their entirety.

### BACKGROUND

### Technical Field

The present invention relates to a ferrule holding structure.

### Discussion of the Background

In the related art, optical connectors for connecting optical fibers to each other have been widespread. With the recent increase in optical communication speed, optical connectors with multiple optical fibers are being used more than optical connectors with a single optical fiber.

Patent Document 1 discloses an optical connector with multiple optical fibers referred to as a multi-fiber push on (MPO) connector. This type of optical connector has a structure in which a plurality of optical fibers is held in one ferrule and the ferrule is held by interposing the ferrule and a biasing member (spring) that biases the ferrule between a housing and a support member (spring push). A biasing force (pressing force) of the biasing member is necessary to press connection surfaces of the ferrule, where the plurality of optical fibers is exposed, against each other to ensure mechanical connection (that is, connection between an optical fiber and another optical fiber) of each optical connector.

Patent Document 2 discloses an MPO connector similar to Patent Document 1. Further, Patent Document 2 discloses that an MPO connector is inserted into an adapter in order to be connected to another MPO connector or the like.

### PATENT DOCUMENTS

Patent Document 1: Published Japanese Translation No. 2018-508045 of the PCT International Publication
Patent Document 2: Japanese Patent Application Publication No. 2018-092125

Although assembly of the holding structure of a ferrule (ferrule holding structure), such as in an optical connector described above in the related art, has been performed in a factory until now. In recent years, it has become increasingly common that assembly is performed by workers at a site where optical fibers are installed.

The assembly of the ferrule holding structure is performed by interposing the ferrule and a biasing member between a housing and a support member that engages with the housing in an extending direction of the optical fiber. Here, in the ferrule holding structure, the required pressing force of the biasing member (hereinafter, referred to as spring pressure) is increased in proportion to the number of optical fibers (number of cores) held by the ferrule. For example, in the ferrule holding structure (optical connector) in which the ferrule holds 12 optical fibers, the required spring pressure is 10 N. Further, in the ferrule holding structure (optical connector) in which the ferrule holds 24 optical fibers, the required spring pressure is 20 N.

When the ferrule holding structure is assembled at the factory, even when the spring pressure is high, the ferrule and the biasing member can be interposed between the housing and the support member by using an appropriate jig or device (large-scale jig or device) for assembly. However, in a case where the above-described jig or device cannot be used at a site, when the spring pressure is high, it becomes difficult to interpose the ferrule and the biasing member between the housing and the support member. That is, there is a case where it becomes difficult to assemble the ferrule holding structure.

### SUMMARY

One or more embodiments provide a ferrule holding structure that is capable of easily performing assembly at a site without any special jigs or devices.

A ferrule holding structure according to one or more embodiments includes: an optical fiber; a ferrule into which the optical fiber is inserted from a rear end to a connection surface as a front end so that the ferrule holds the optical fiber; a biasing member biasing the ferrule in a forward direction from the rear end toward the connection surface; a housing accommodating at least part of the ferrule and the biasing member inside the housing; and a support member engaged with the housing and supporting a rear end side of the biasing member. The support member includes a guide portion that makes the support member movable with respect to the housing in an intersecting direction that intersects a forward-rearward direction, and a pressing face that is configured to press the biasing member in the forward direction along with a movement of the support member toward one side in the intersecting direction to a position where the support member engages with the housing.

According to one or more embodiments, the assembly of a ferrule holding structure can easily be performed at a site without any special jigs or devices.

### BRIEF DESCRIPTION OF THE DRAWINGS

FIG. 1 is a perspective view showing a ferrule holding structure according to one or more embodiments in a state in which one support member is detached.

FIG. 2 is a cross-sectional view taken along line II-II in FIG. 1.

FIG. 3 is a cross-sectional view taken along line III-III in FIG. 1.

FIG. 4 is a perspective view showing a state in which one ferrule unit is detached from a housing in the ferrule holding structure in FIG. 1.

FIG. 5 is a disassembled perspective view showing an optical fiber, a biasing member, a tubular member, and a spacer member in the ferrule unit in FIG. 4.

FIG. 6 is a perspective view showing a main portion of the ferrule holding structure in FIG. 1 in an enlarged manner.

FIG. 7 is a perspective view showing a process of attaching the support member to the housing from the state shown in FIG. 6.

FIG. 8 is a cross-sectional view showing a state corresponding to FIG. 7.

### DESCRIPTION OF THE EMBODIMENTS

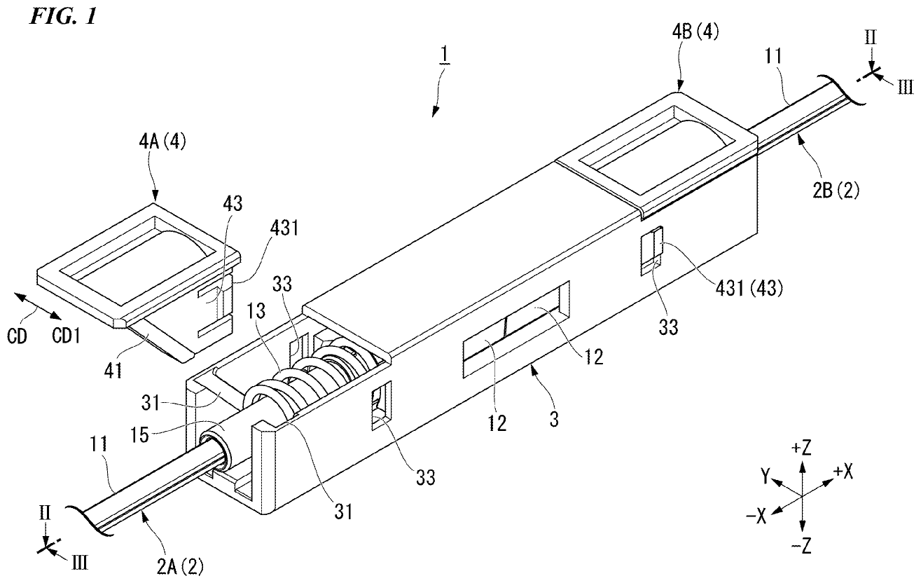

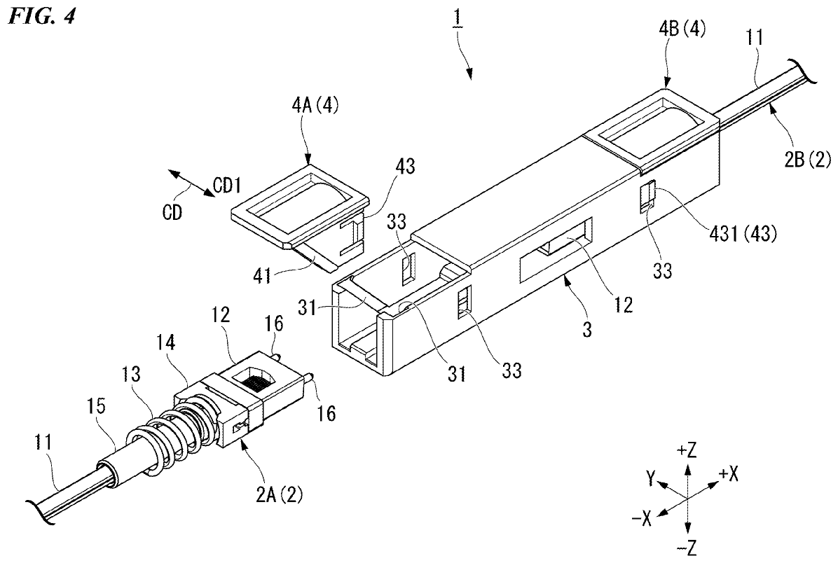

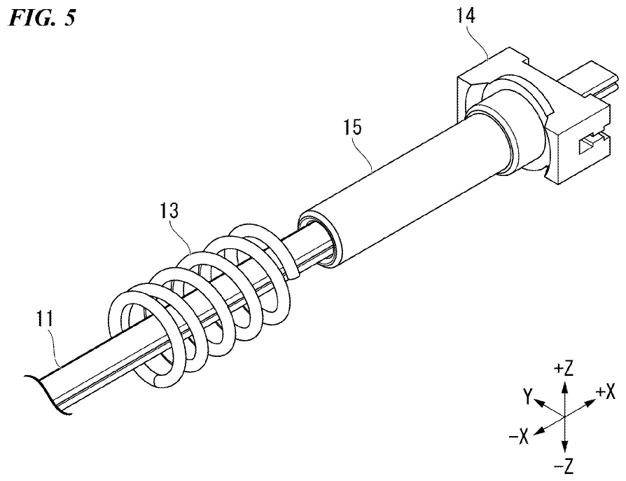

Hereinafter, embodiments will be described with reference to FIGS. 1 to 8.

As shown in FIGS. 1 to 3, a ferrule holding structure 1 of one or more embodiments configures an optical connector for connecting optical fibers 11 held by the ferrule 12 to each other.

The ferrule holding structure 1 includes ferrule units 2 (2A, 2B), a housing 3, and support members 4 (4A, 4B). The ferrule unit 2 connects the optical fiber 11 included therein to an optical fiber 11 of another ferrule unit 2. The ferrule holding structure 1 of the one or more embodiments includes two ferrule units 2. The housing 3 is configured as an adapter for connecting the two ferrule units 2. In the following description, one of the two ferrule units 2 may be referred to as a first ferrule unit 2A, and the other may be referred to as a second ferrule unit 2B.

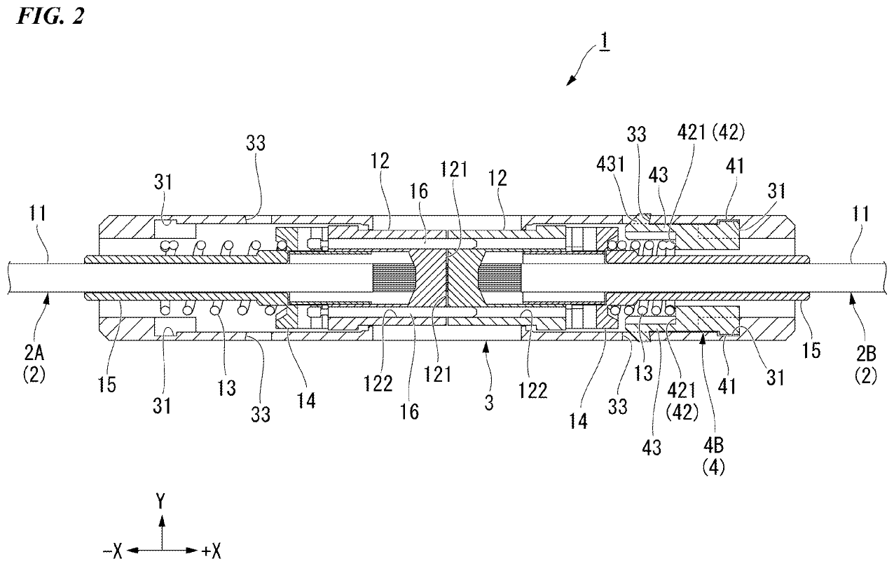

As shown in FIGS. 2 to 4, the first ferrule unit 2A includes an optical fiber 11, a ferrule 12, and a biasing member 13. And, the first ferrule unit 2A further includes a spacer member 14 and a tubular member 15. The ferrule 12 includes a connection surface 121 into which the optical fiber 11 is inserted and a tip of the optical fiber 11 is exposed.

In the following description, a direction in which the optical fiber 11 is inserted into the ferrule 12 is referred to as a forward-rearward direction X. Further, in the first ferrule unit 2A, a connection surface 121 side of the ferrule 12 in the forward-rearward direction X is referred to as a forward direction (+X), and an opposite direction is referred to as a rearward direction (−X). One direction (orthogonal direction) orthogonal to the forward-rearward direction X is referred to as an upward-downward direction Z. Further, one side in the upward-downward direction Z is referred to as an upward direction (+Z), and the other side is referred to as a downward direction (−Z). A direction orthogonal to both the forward-rearward direction X and the upward-downward direction Z is called a left-right direction Y.

The ferrule 12 holds the optical fiber 11 by inserting the optical fiber 11 from a rear end to the connection surface 121 as a front end. The tip of the optical fiber 11 is exposed on the connection surface 121 of the ferrule 12. The number of optical fibers 11 held by the ferrule 12 (the number of optical fibers 11 exposed on the connection surface 121) may be any number.

The ferrule 12 includes a guide hole 122 penetrating in the forward-rearward direction X from the connection surface 121 (front end) to the rear end. A guide pin 16 can be inserted into the guide hole 122. The guide pin 16 positions the ferrule 12 of the first ferrule unit 2A and the ferrule 12 of the second ferrule unit 2B relative to each other. In one or more embodiments, the guide pin 16 is attached to the ferrule 12 of the first ferrule unit 2A. The guide pin 16 is inserted into the guide hole 122 of the ferrule 12 of the second ferrule unit 2B when the connection surfaces 121 of the ferrules 12 of the first and second ferrule units 2A and 2B are in abutting each other.

The biasing member 13 is disposed on a rear end side of the ferrule 12 and biases the ferrule 12 in the forward direction from the rear end toward the connection surface 121 (front end). The biasing member 13 may have any specific configuration. The biasing member 13 in one or more embodiments is a coil spring. Although the coil spring in the shown example has a circular shape when viewed in the forward-rearward direction X, the coil spring may have an elliptical shape, for example.

The spacer member 14 is provided between the ferrule 12 and the biasing member 13. The spacer member 14 supports a front end of the biasing member 13 positioned on a ferrule 12 side. Although not shown, the spacer member 14 is formed with an insertion hole into which the optical fiber 11 extending in the rear side of the ferrule 12 (rearward direction) is inserted on the rear side. The spacer member 14 of one or more embodiments also functions as a pin clamp that holds the above-described guide pin 16.

As shown in FIGS. 2 to 5, the tubular member 15 is disposed on the rear end side of the ferrule 12 such that an axial direction thereof extends in the forward-rearward direction X. The optical fiber 11 extending on the rear side of the ferrule 12 is inserted into the tubular member 15. Further, the tubular member 15 is inserted inside the biasing member 13, which is a coil spring. In such a state, the biasing member 13 is positioned on an outer peripheral side of the tubular member 15. In one or more embodiments, the tubular member 15 is integrally formed with the spacer member 14.

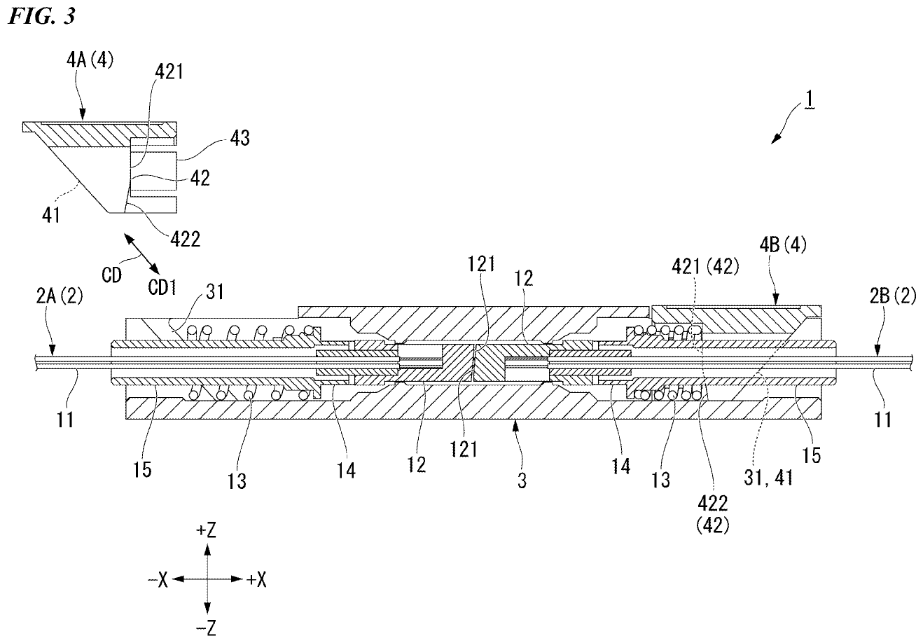

As shown in FIGS. 2 and 3, the configuration of the second ferrule unit 2B is similar to the configuration of the first ferrule unit 2A described above. However, in the second ferrule unit 2B, the −X direction of the forward-rearward direction X corresponds to the forward direction of the ferrule 12, and the +X direction corresponds to the rearward direction of the ferrule 12. That is, the second ferrule unit 2B faces a side opposite to the first ferrule unit 2A in the forward-rearward direction X. As a result, the connection surfaces 121 of each of the ferrules 12 of the first and second ferrule units 2A and 2B face each other in the forward-rearward direction X.

As shown in FIGS. 1 to 4, the housing 3 is formed in a tubular shape extending in the forward-rearward direction X. The housing 3 accommodates the ferrule 12 and the biasing member 13 therein. In one or more embodiments, the spacer member 14 and the tubular member 15 are also accommodated inside the housing 3. In the shown example, each of the ferrule 12, the biasing member 13, and the spacer member 14 are all accommodated in the housing 3. Further, part of the tubular member 15 is accommodated in the housing 3, and a rear end portion (remaining portion) of the tubular member 15 is positioned outside the housing 3 in the forward-rearward direction X. The ferrule 12, which is accommodated inside the housing 3, is restricted by the housing 3 so as not to move in the forward direction beyond a predetermined position with respect to the housing 3.

The first ferrule unit 2A is accommodated in the housing 3 by being inserted into the housing 3 with the +X direction as the forward direction. The second ferrule unit 2B is accommodated in the housing 3 by being inserted into the housing 3 with the −X direction as the forward direction. That is, the first and second ferrule units 2A and 2B are inserted into the housing 3 opposite to each other in the forward-rearward direction X. As a result, the connection surfaces 121 of each of the ferrules 12 of the first and second ferrule units 2A and 2B can be abutted against each other.

The support member 4 (spring push) supports the rear end side of the biasing member 13 by being engaged with the housing 3. The support member 4 interposes the ferrule 12 and the biasing member 13, which are accommodated in the housing 3, between the support member 4 and the housing 3 in the forward-rearward direction X in a state in which the support member 4 is engaged with the housing 3. In such a state, the biasing member 13 is elastically compressed in the forward-rearward direction X and biases the ferrule 12 in the forward direction.

The ferrule holding structure 1 of one or more embodiments includes two support members 4. Among the two support members 4, a first support member 4A corresponds to the first ferrule unit 2A, and a second support member 4B corresponds to the second ferrule unit 2B.

In FIGS. 1 to 3, the first support member 4A is detached from the housing 3, that is, is not engaged with the housing 3. Therefore, the biasing member 13 of the first ferrule unit 2A is not elastically compressed and does not bias the ferrule 12 of the first ferrule unit 2A in the forward direction (+X direction). On the other hand, the second support member 4B is attached to the housing 3, that is, is engaged with the housing 3. As a result, the biasing member 13 of the second ferrule unit 2B is elastically compressed and biases the ferrule 12 of the second ferrule unit 2B in the forward direction (−X direction).

As shown in FIGS. 2, 3, and 6, the support member 4 includes a guide portion 41 and a pressing face 42. The guide portion 41 makes the support member 4 movable with respect to the housing 3 in an intersecting direction that intersects the forward-rearward direction X. The pressing face 42 is a face for pressing the biasing member 13 in the forward direction as the support member 4 moves to one side in the intersecting direction to a position where the support member 4 engages with the housing 3. In one or more embodiments, the intersecting direction in which the support member 4 moves with respect to the housing 3 is an inclination direction CD that is linearly inclined with respect to both the forward-rearward direction X and the upward-downward direction Z. The housing 3 includes a rail portion (rail) 31 that guides the guide portion 41 of the support member 4 described above only in the inclination direction CD (intersecting direction).

Hereinafter, the support member 4 and the rail portion 31 of the housing 3 of one or more embodiments will be specifically described.

The support member 4 is attached to a portion (that is, an opening portion of the housing 3) of the housing 3 that corresponds to a rear end portion of the ferrule unit 2 attached to the housing 3. Further, the support member 4 is attached to the housing 3 by approaching the housing 3 from a direction orthogonal to the forward-rearward direction X. In the shown example, the support member 4 is attached to the housing 3 from an upper side (+Z side) of the housing 3.

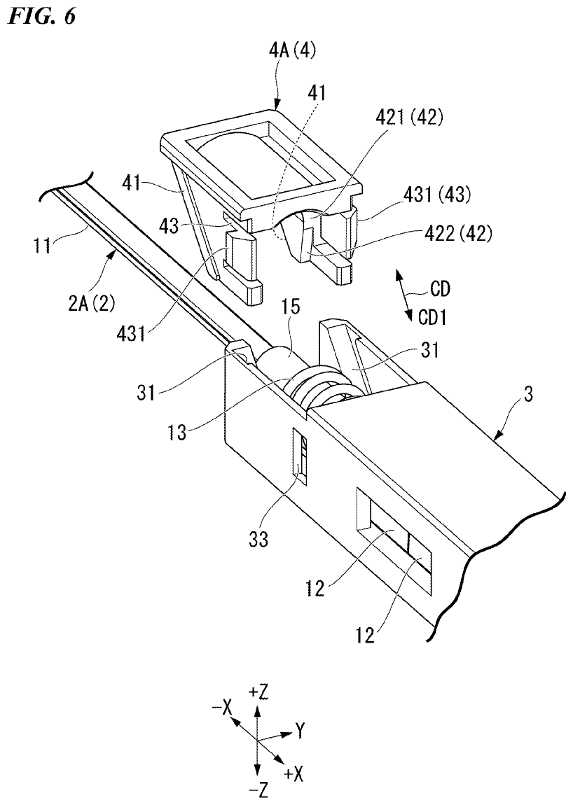

As shown in FIGS. 2 and 6, the guide portions 41 of the support member 4 are provided at both ends of the support member 4 in the left-right direction Y. Each of the guide portions 41 on both (left and right) ends protrudes outside of the support member 4 in the left-right direction Y. The guide portion 41 extends linearly in the inclination direction CD toward the downward direction (−Z direction) as the guide portion 41 moves toward the forward direction (+X direction in the case of the first ferrule unit 2A) of the ferrule unit 2.

The rail portions 31 of the housing 3 are provided at both ends of the housing 3 in the left-right direction Y at end portions of the housing 3 in the forward-rearward direction X. The rail portions 31 on both (left and right) ends are provided on an inner face of the housing 3 facing the left-right direction Y. The rail portion 31 of one or more embodiments is a groove that linearly extends in a direction corresponding to a direction (inclination direction CD) in which the guide portion 41 extends.

As shown in FIGS. 2, 7, and 8, the guide portion 41 of the support member 4 is inserted into the rail portion 31 formed in a groove shape. By inserting the guide portion 41 into the rail portion 31, the support member 4 is restricted from moving with respect to the housing 3 in a direction other than the inclination direction CD. That is, the support member 4 is guided only in the inclination direction CD by the rail portion 31 of the housing 3. Further, for example, the guide portion 41 of the support member 4 may be formed in a groove shape, and the rail portion 31 of the housing 3 may be formed in a protruding shape that enters the guide portion 41 having a groove shape. That is, the rail portion 31 may be inserted into the guide portion 41.

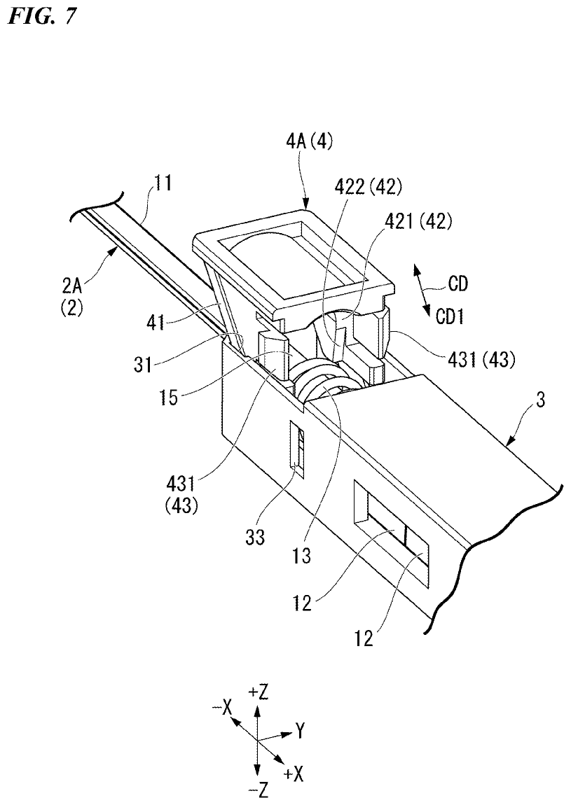

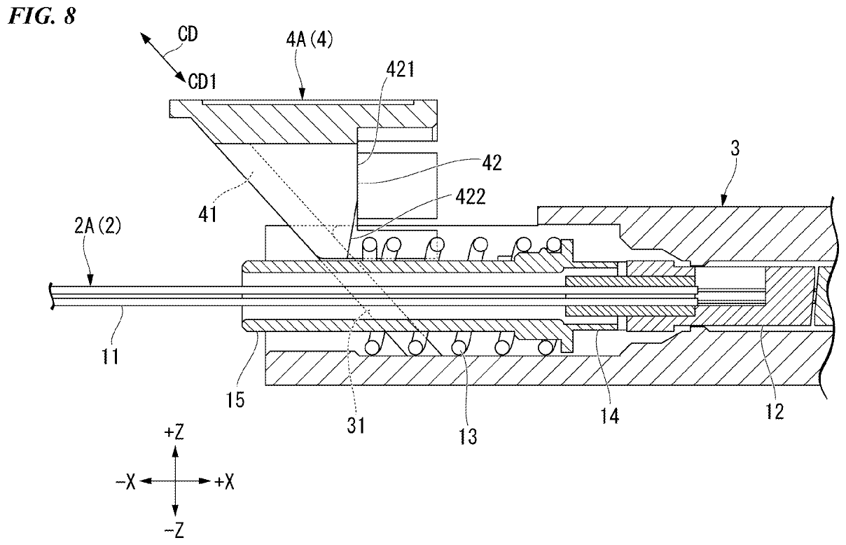

As shown in FIGS. 7 and 8, the support member 4 is attached to the housing 3 by being moved to one side (CD1 direction in the first ferrule unit 2A) in the inclination direction CD with respect to the housing 3 and presses the biasing member 13 in the forward direction. The CD1 direction is a direction toward the +X side and the −Z side.

As shown in FIGS. 3 and 6, the pressing face 42 of the support member 4 for pressing the biasing member 13 in the forward direction is a face that faces a forward direction side (+X side in the case of the first ferrule unit 2A). The pressing face 42 of the support member 4 of one or more embodiments includes an orthogonal face 421 and an inclination guide face 422. The orthogonal face 421 is a face orthogonal to the forward-rearward direction X. The inclination guide face 422 is inclined toward the rearward direction (−X direction in the case of the first ferrule unit 2A) as the inclination guide face 422 moves in the downward direction (one side in the orthogonal direction). The inclination guide face 422 is positioned at an end portion of the pressing face 42 in the downward direction. Further, the inclination guide face 422 is positioned adjacent to a lower side of the orthogonal face 421.

As shown in FIGS. 2 and 6, the support member 4 includes an engaging portion 43 that is engaged with an engaged portion 33 of the housing 3. The engaging portion 43 engages with the engaged portion 33 of the housing 3 in a state in which the pressing face 42 of the support member 4 is pressed against the biasing member 13. In a state in which the engaging portion 43 of the support member 4 is engaged with the engaged portion 33 of the housing 3, the biasing member 13 is interposed between the housing 3 and the support member 4, and the biasing member 13 is held in a compressed state.

The engaging portions 43 of the support member 4 in one or more embodiments are engagement claws 43 provided on both end portions of the support member 4 in the left-right direction Y. Each of the engagement claws 43 is elastically and flexibly deformable in the left-right direction Y. The engagement claw 43 includes an engagement protruding portion 431 protruding outside the support member 4 in the left-right direction Y. In the shown example, although the engagement claw 43 is positioned in the forward direction (+X direction in the case of the first ferrule unit 2A) with respect to the pressing face 42, one or more embodiments are not limited thereto.

The engaged portion 33 of the housing 3 in one or more embodiments is an engagement hole 33 formed by being recessed from the inner face of the housing 3 in the left-right direction Y. Although the engagement hole 33 may penetrate to an outer face of the housing 3 in the left-right direction Y as in the shown example, the engagement hole 33 does not have to penetrate, for example. That is, the engagement hole 33 may have a shape in which the engagement protruding portion 431 can engage and may have a recessed shape, for example.

As shown in FIGS. 2, 6, and 7, the support member 4 is movable with respect to the housing 3 on an outer peripheral side of the tubular member 15 of the ferrule unit 2 accommodated in the housing 3. The support member 4 is configured not to interfere with the tubular member 15 even when the support member 4 is attached to the housing 3. Specifically, portions including the guide portion 41, the pressing face 42, and the engagement claw 43 of the support member 4 are positioned at both end portions of the support member 4 in the left-right direction Y and are not positioned at a center portion of the support member 4 in the left-right direction Y. As a result, in a state in which the support member 4 is attached to the housing 3, portions of the support member 4 including the guide portion 41, the pressing face 42, and the engagement claw 43 are positioned on both sides (that is, the outer peripheral sides of the tubular member 15) of the tubular member 15 in the left-right direction Y.

Next, in the ferrule holding structure 1 of one or more embodiments, a method of attaching the support member 4 to the housing 3 and interposing the biasing member 13 between the housing 3 and the support member 4 will be described. In the following description, the procedure of interposing the biasing member 13 of the first ferrule unit 2A between the housing 3 and the first support member 4A will be described, and the same applies to the case of the second ferrule unit 2B.

In this method, as shown in FIGS. 1 to 3 and 6, the first ferrule unit 2A is inserted into and accommodated in the housing 3 in advance. In such a state, the first support member 4A is moved in the downward direction (−Z direction) toward the housing 3, and as shown in FIGS. 7 and 8, the guide portion 41 of the first support member 4A is inserted into the rail portion 31 of the housing 3.

Thereafter, when the first support member 4A is further moved in the downward direction toward the housing 3, the first support member 4A is moved to one side (CD1 direction) in the inclination direction CD by the guide portion 41 and the rail portion 31. At this time, the pressing face 42 of the first support member 4A comes into contact with the rear end of the biasing member 13. In one or more embodiments, first, the inclination guide face 422 of the pressing face 42 comes into contact with the rear end of the biasing member 13. As the pressing face 42 of the first support member 4A advances in the forward direction by further moving the first support member 4A in the downward direction, the pressing face 42 of the first support member 4A presses the biasing member 13 in the forward direction. Moreover, by moving the first support member 4A in the downward direction, the orthogonal face 421 of the pressing face 42 positioned on the upper side of the inclination guide face 422 of the first support member 4A is pressed against the rear end of the biasing member 13. Since the orthogonal face 421 is a face orthogonal to the forward-rearward direction X, the rear end of the biasing member 13 can be stably pressed in the forward direction. As the rear end of the biasing member 13 is pressed in the forward direction by the first support member 4A in this way, the biasing member 13 is interposed between the housing 3 and the first support member 4A in the forward-rearward direction X and is elastically compressed.

Finally, the engaging portion 43 of the first support member 4A engages with the engaged portion 33 of the housing 3, so that the first support member 4A is held in a state in which the rear end side of the biasing member 13 is supported. That is, the biasing member 13 is held in a state in which the biasing member 13 is interposed between the housing 3 and the first support member 4A. As described above, the method of interposing the biasing member 13 between the housing 3 and the first support member 4A is completed. FIGS. 2 to 3 show a mode in which the biasing member 13 of the second ferrule unit 2B is held in a state of being interposed between the housing 3 and the support member 4.

In the ferrule holding structure 1 of one or more embodiments, the engagement protruding portion 431 of the engagement claw 43 of the support member 4, which is engaged with the engagement hole 33 of the housing 3 from the inside, is exposed to the outside of the housing 3 through the engagement hole 33. Therefore, an engagement state of the engaging portion 43 of the support member 4 with respect to the engaged portion 33 of the housing 3 can be released. That is, the support member 4 can be attached to the housing 3 in an attachable and detachable manner.

As described above, according to the ferrule holding structure 1 of one or more embodiments, the force with which a worker presses the support member 4 in the downward direction (orthogonal direction) with respect to the housing 3 can be converted into the forward direction (+X direction in the case of the first ferrule unit 2A), and the biasing member 13 can be pressed in the forward direction. By converting the direction of the force for pressing the support member 4 in this manner, even when the force for pressing the support member 4 is small, it is possible to press the biasing member 13 in the forward direction with a large force. For example, as in one or more embodiments, when the direction in which the support member 4 is pressed and the direction in which the biasing member 13 is pressed form an angle of 90 degrees, the biasing member 13 can be pressed in the forward direction with twice the force pressing the support member 4 in the intersecting direction. As a result, even with a small force, the biasing member 13 having a high spring pressure can be interposed between the housing 3 and the support member 4. Therefore, it is possible to easily assemble the ferrule holding structure 1 on site without any special jigs or devices.

In the ferrule holding structure 1 of one or more embodiments, the housing 3 includes the rail portion 31 that guides the guide portion 41 of the support member 4 only in the inclination direction CD (intersecting direction). As a result, it is possible to prevent the support member 4 from moving with respect to the housing 3 in a direction other than the inclination direction CD. Therefore, the biasing member 13 can stably be pressed in the forward direction with the support member 4.

In the ferrule holding structure 1 of one or more embodiments, the support member 4 is movable with respect to the housing 3 in the inclination direction CD that is linearly inclined with respect to both the forward-rearward direction X and the upward-downward direction Z (orthogonal direction). As a result, by moving the support member 4 to one side (CD1 direction) of the linear inclination direction CD with respect to the housing 3, the pressing face 42 of the support member 4 can be moved in the forward direction.

In the ferrule holding structure 1 of one or more embodiments, the pressing face 42 of the support member 4 includes the inclination guide face 422 inclined toward the rearward direction (−X direction in the case of the first ferrule unit 2A) as the inclination guide face 422 moves toward the downward direction (one side in the orthogonal direction; −Z direction). Therefore, based on the dimensional tolerance of the biasing member 13 or the like, even when the rear end of the biasing member 13 is positioned in the rearward direction from the designed position, the pressing face 42 can be reliably pressed against the rear end of the biasing member 13.

In the ferrule holding structure 1 of one or more embodiments, the optical fiber 11 positioned on the rear side of the ferrule 12 is protected by the tubular member 15. The support member 4 is movable with respect to the housing 3 on the outer peripheral side of the tubular member 15. Therefore, when the support member 4 is moved with respect to the housing 3 on the rear side of the ferrule 12, it is possible to prevent the support member 4 from coming into contact with the optical fiber 11. That is, the optical fiber 11 can be protected from the support member 4 by the tubular member 15.

In the ferrule holding structure 1 of one or more embodiments, the biasing member 13 is positioned on the outer peripheral side of the tubular member 15. As a result, it is possible to prevent the biasing member 13 from coming into contact with the optical fiber 11 on the rear side of the ferrule 12. That is, the optical fiber 11 can be protected from the biasing member 13 by the tubular member 15.

The ferrule holding structure 1 of one or more embodiments can also be used when the length of the ferrule 12 or the like in the left-right direction Y is large. Hereinafter, such a case will be described.

For example, when the number of optical fibers 11 held by the ferrule 12 increases, the dimension of the ferrule 12 in the left-right direction Y increases by arranging a large number of optical fibers 11 in the left-right direction Y. In this case, the dimension in the left-right direction Y of the biasing member 13 positioned on the rear side of the ferrule 12 also increases. Therefore, the length in the left-right direction Y of the support member 4, which presses the biasing member 13 having a large length of the left-right direction Y in the forward direction, increases. Accordingly, the face of the support member 4, which is pressed from the upward direction by the worker, is enlarged in the left-right direction Y. By enlarging the size of the face of the support member 4 that is pressed from the upward direction by the worker, the biasing member 13 can be strongly pressed in the forward direction even when the worker reduces the face pressure for pressing the face of the support member 4 in the downward direction. From the above, the worker can interpose the biasing member 13, which has a high spring pressure, between the housing 3 and the support member 4 with a small force.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

In one or more embodiments, the pressing face 42 of the support member 4 may be composed of, for example, only the orthogonal face 421 or only the inclination guide face 422.

In one or more embodiments, the guide portion 41 of the support member 4 may be configured such that the support member 4 is movable with respect to the housing 3, for example, in the orthogonal direction (for example, the upward-downward direction Z) that is orthogonal to the forward-rearward direction X, rather than in the inclination direction CD as in the above embodiments. In this case, the pressing face 42 of the support member 4 is preferably the inclination guide face 422. By using the pressing face 42 as the inclination guide face 422, when the support member 4 is moved to one side (for example, the downward direction) in the orthogonal direction with respect to the housing 3 and is attached to the housing 3, the pressing face 42 can press the rear end of the biasing member 13 in the forward direction with the support member 4. As a result, the same effects as those of the embodiments can be obtained.

In one or more embodiments, the housing 3 may not include the rail portion 31. The housing 3 only needs to include at least a face toward the forward direction, that is, the face supporting the guide portion 41 from the rear side for guiding the guide portion 41 in the intersecting direction (for example, the inclination direction CD similar to the above embodiments).

In one or more embodiments, the housing 3 is not limited to being configured as an adapter to which the two ferrule units 2 and the support member 4 are attached, and for example, the housing 3 may be configured such that only one ferrule unit 2 can be attached. In this case, the housing 3 is configured as the optical connector together with the one ferrule unit 2 and the support member 4. In such a configuration, the front end portion of the ferrule 12 including the connection surface 121 may be disposed outside the housing 3, for example. That is, the housing 3 may accommodate at least part of the ferrule 12.

### REFERENCE SIGNS LIST

1: Ferrule holding structure
3: Housing
4: Support member
11: Optical fiber
12: Ferrule
13: Biasing member
15: Tubular member
31: Rail portion
41: Guide portion
42: Pressing face
121: Connection surface
CD: Inclination direction (intersecting direction)
X: Forward-rearward direction
Z: Upward-downward direction (orthogonal direction)

1. A ferrule holding structure comprising:
an optical fiber;
a ferrule:
into which the optical fiber is inserted from a rear end of the ferrule to a connection surface at a front end of the ferrule, and
that holds the optical fiber;
a biasing member that biases the ferrule in a forward direction from the rear end toward the connection surface;
a housing that accommodates the biasing member and at least a part of the ferrule; and
a support member that engages with the housing and that supports a rear end side of the biasing member, wherein
the support member moves with respect to the housing and includes:
a guide portion that guides the support member into the housing in an intersecting direction intersecting a forward-rearward direction of the ferrule holding structure; and
a pressing face that presses the biasing member in the forward direction along with a movement of the support member in the intersecting direction to a position where the support member engages with the housing.

2. The ferrule holding structure according to claim 1, wherein the housing includes a rail that guides the guide portion only in the intersecting direction.

3. The ferrule holding structure according to claim 1, wherein the intersecting direction is an inclination direction linearly inclined with respect to both of the forward direction and an orthogonal direction orthogonal to the forward direction.

4. The ferrule holding structure according to claim 1, wherein the pressing face includes an inclination guide face inclined toward a rearward direction opposite to the forward direction along an orthogonal direction orthogonal to the forward direction.

5. The ferrule holding structure according to claim 1, further comprising:
a tubular member, disposed on the rear end of the ferrule, into which the optical fiber extending in a rear side of the ferrule is inserted, wherein
the support member moves with respect to the housing on an outer peripheral side of the tubular member.

6. The ferrule holding structure according to claim 1, further comprising:
a tubular member, disposed on the rear end of the ferrule, into which the optical fiber extending in a rear side of the ferrule is inserted, wherein
the biasing member is disposed on an outer peripheral side of the tubular member.
